(19) United States
(12) Patent Application Publication
(10) Pub. No.: US 2010/0196073 A1
(43) Pub. Date: Aug. 5, 2010

(54) SHEET CONVEYING APPARATUS AND IMAGE FORMING APPARATUS

(75) Inventor: Hiroyuki TAKI, Shizuoka-ken (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/698,402

(22) Filed: Feb. 2, 2010

Related U.S. Application Data
(60) Provisional application No. 61/150,272, filed on Feb. 5, 2009.

(51) Int. Cl. G03G 15/00; B65H 5/02; B65H 7/20; B65H 31/24

(52) U.S. Cl. 399/405; 271/4.09; 271/4.04; 271/279

(57) ABSTRACT

A sheet conveying apparatus distributes and conveys sheets to plural storage trays. The apparatus includes a flapper configured to guide a sheet to each of the plural storage trays by changing an angle thereof, a conveying roller configured to discharge the sheet moved along the flapper to each of the storage trays, and a link member which is connected to the flapper and the conveying roller, and rotates to change the angle of the flapper and a position of the conveying roller with respect to the plural storage trays.

### CROSS-REFERENCE TO RELATED APPLICATION

This application is based upon and claims the benefit of priority from: U.S. provisional application 61/150,272, filed on Feb. 5, 2009 the entire contents of each of which are incorporated herein by reference.

### TECHNICAL FIELD

The present invention relates to a technique to distribute and convey sheets to plural storage trays.

### BACKGROUND

In an image forming apparatus, a space (sheet discharge space) for discharging a sheet on which an image is formed is required. In an up-and-down direction of some image forming apparatus, the sheet discharge space is provided between a scanner and an image forming section. The size of the sheet discharge space is regulated according to the positional relation between the scanner and the image forming section, and the like.

In order to suppress the enlargement of the image forming apparatus, the sheet discharge space is limited. Then, it is necessary to efficiently use the limited sheet discharge space.

### SUMMARY

According to an aspect of the invention, a sheet conveying apparatus configured to distribute and convey sheets to plural storage trays includes a flapper configured to guide a sheet to each of the plural storage trays by changing an angle thereof, a conveying roller configured to discharge the sheet moved along the flapper to each of the storage trays, and a link member which is connected to the flapper and the conveying roller, and rotates to change the angle of the flapper and a position of the conveying roller with respect to the plural storage trays.

According to another aspect of the invention, an image forming apparatus includes an image forming section configured to form an image on a sheet, and the sheet conveying apparatus configured to convey the sheet on which the image is formed by the image forming section to the plural storage trays.

According to another aspect of the invention, a sheet conveying method for distributing and conveying sheets to a plurality of storage trays, includes: rotating a link member in a first rotation direction by using an urging force of an urging member, the link member being connected to a flapper and a conveying roller; rotating the link member in a second rotation direction by an actuator, the second rotation direction being a reverse direction to the first rotation direction, the actuator generating a force against the urging force of the urging member; guiding the sheet to each of the plurality of storage trays by changing an angle of the flapper through the rotation of the link member in the first and second directions; and discharging the sheet moved along the flapper to each of the storage trays by changing a position of the conveying roller with respect to the plurality of storage trays through the rotation of the link member and then rotating the conveying roller.

### DESCRIPTION OF THE DRAWINGS

FIG. 1 is a schematic view showing a structure of an image forming apparatus of a first embodiment of the invention.

FIG. 2 is a perspective view of a conveyance path changing mechanism in the first embodiment.

FIG. 3 is a schematic view showing a drive mechanism of a conveyance alignment roller in the first embodiment.

FIG. 4 is a schematic view showing the conveyance path changing mechanism when the conveyance alignment roller is in contact with an upper pinch roller.

FIG. 5 is a schematic view showing the conveyance path changing mechanism when the conveyance alignment roller is in contact with a lower pinch roller.

FIG. 6 is a schematic view showing a drive mechanism of the conveyance alignment roller in a state shown in FIG. 5.

FIG. 7 is a view showing a circuit to drive a drive motor and a solenoid.

FIG. 8 is a flowchart showing control of the conveyance path changing mechanism.

### DETAILED DESCRIPTION

Hereinafter, embodiments of the invention will be described with reference to the drawings.

### First Embodiment

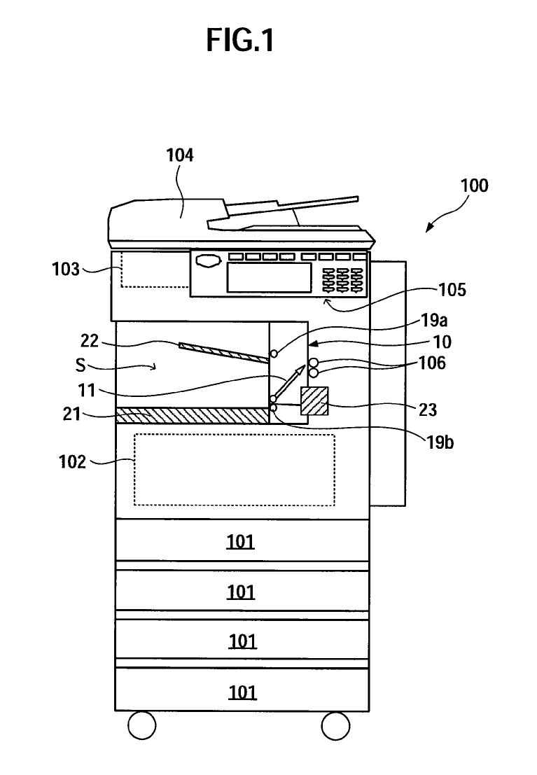

A sheet conveying apparatus of a first embodiment of the invention will be described. First, an image forming apparatus including the sheet conveying apparatus of this embodiment will be described with reference to FIG. 1. FIG. 1 is a front view showing the outline of the image forming apparatus (MFP: Multi Function Peripheral).

An image forming apparatus 100 includes plural paper feed cassettes 101, and each of the paper feed cassettes 101 contains plural sheets. The plural sheets contained in each of the paper feed cassettes 101 are separated by a pickup roller one by one and are supplied to a sheet conveyance path. Then, the sheet passes through the sheet conveyance path and is supplied to an image forming section 102.

The image forming section 102 forms a developer image on the sheet based on image data or the like. The image data includes, for example, image data transmitted from an external equipment (for example, a personal computer) to the image forming apparatus 100, and image data generated by a reading operation of an image reading section 103.

The image reading section 103 scans an image of a sheet document and a book document and generates image data. FIG. 1 shows a part of the image reading section 103. An apparatus (ADF: Auto Document Feeder) 104 automatically feeds a document to the image reading section 103 and is disposed above the image reading section 103.

An operation panel 105 is used for inputting various information (well known) to the image forming apparatus 100 and is provided at an upper part of the image forming apparatus 100. The operation panel 105 includes, for example, a button switch or a liquid crystal panel.

In the image forming section 102, specifically, after an electrostatic latent image corresponding to the image data is formed on a photoconductive surface of a photoreceptor, a developer is supplied to form a developer image. The developer image formed on the surface of the photoreceptor is transferred to the sheet. The sheet is brought into contact with the surface of the photoreceptor, so that the developer image can be transferred to the sheet. Besides, after the developer image on the photoreceptor is transferred to an intermediate transfer belt, it can be transferred from the intermediate transfer belt to the sheet.

The developer image transferred to the sheet is heated and fixed to the sheet by a fuser unit (not shown). The sheet on which the developer image is fixed passes through the sheet conveyance path, and is conveyed from a conveying roller 106 to a finisher (sheet conveyance apparatus) 10. The finisher 10 discharges the sheet from the conveying roller 106 to a sheet discharge space S.

The sheet discharge space S is positioned between the image forming section 102 and the image reading section 103 in the up-and-down direction of the image forming apparatus 100. In other words, when viewed from above the image forming apparatus 100, the sheet discharge space S is disposed to overlap with the image forming section 102 and the image reading section 103. A first storage tray 21 and a second storage tray 22 are disposed in the sheet discharge space S, and the second storage tray 22 is disposed above the first storage tray 21. The sheets conveyed from the finisher 10 are stacked on the storage trays 21 and 22, respectively.

The finisher 10 is disposed at a position adjacent to the sheet discharge space S, and is positioned between the image forming section 102 and the image reading section 103 in the up-and-down direction of the image forming apparatus 100. The finisher 10 distributes the sheets conveyed from the conveying roller 106 to the first storage tray 21 and the second storage tray 22. Specifically, a conveyance path changing mechanism 11 included in the finisher 10 distributes the sheets from the conveying roller 106 to the first storage tray 21 and the second storage tray 22.

The finisher 10 includes a stapler 23, and the stapler 23 staples the sheets from the conveying roller 106. Besides, the finisher 10 includes pinch rollers 19a and 19b at positions corresponding to the first storage tray 21 and the second storage tray 22.

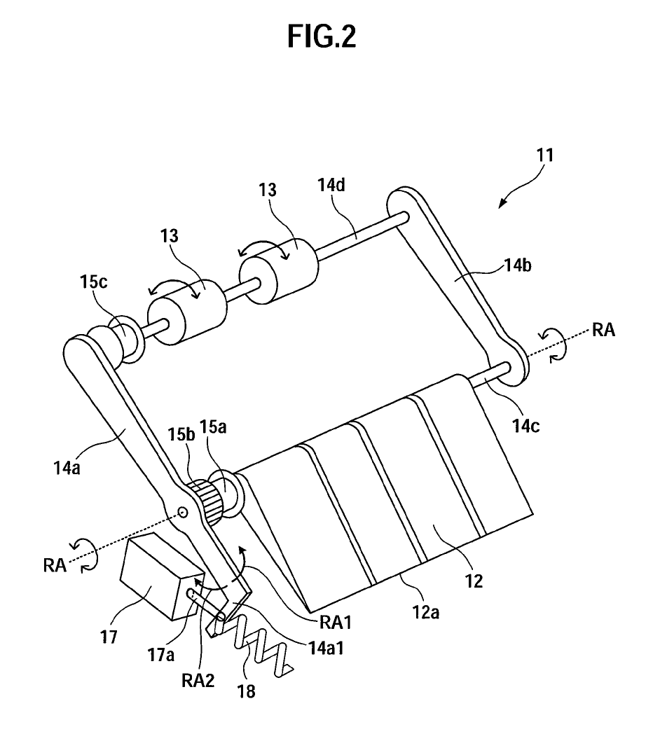

Next, a specific structure of the conveyance path changing mechanism 11 will be described with reference to FIG. 2.

The conveyance path changing mechanism 11 includes a flapper 12, a conveyance alignment roller 13, and a pair of link members 14a and 14b. The pair of link members 14a and 14b couple the flapper 12 to the conveyance alignment roller 13. The link members 14a and 14b are supported by the main body of the finisher 10, and rotate around a rotation axis RA.

Both ends of a first support bar 14c are fixed to the pair of link members 14a and 14b, and the first support bar 14c is disposed on the rotation axis RA. The first support bar 14c rotates in accordance with the rotation of the link members 14a and 14b. The flapper 12 is fixed to the first support bar 14c, and the orientation of the flapper 12 is changed in accordance with the rotation of the link members 14a and 14b. In other words, the flapper 12 swings around the rotation axis RA, and a position of a front end 12a of the flapper 12 is changed in accordance with the rotation of the support bar 14c.

A second support bar 14d is rotatably attached to the pair of link members 14a and 14b, and is disposed at a position separate from the rotation axis RA. The two conveyance alignment rollers 13 are fixed to the second support bar 14d, and the conveyance alignment rollers 13 are rotated by the rotation of the second support bar 14d.

In this embodiment, although the two conveyance alignment rollers 13 are used, the number of the conveyance alignment rollers 13 can be one or three or more.

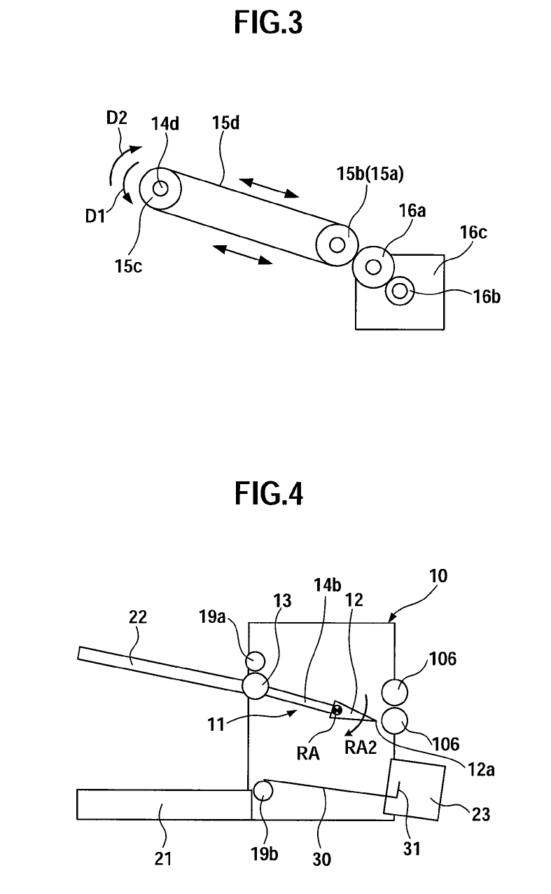

A first pulley 15a is rotatably attached to the first support bar 14c. The first pulley 15a and a gear 15b are integrally formed. A second pulley 15c is fixed to the second support bar 14d. As shown in FIG. 3, the first pulley 15a and the second pulley 15c are engaged with a belt 15d. In FIG. 2, the belt 15d is omitted. The belt 15d transmits the rotation force of the first pulley 15a to the second pulley 15c.

As shown in FIG. 3, a drive motor 16c is connected to the gear 15b rotating together with the first pulley 15a through gear trains 16a and 16b. Since the first pulley 15a and the gear 15b are disposed on the rotation axis RA, even if the link members 14a and 14b are rotated, the positions of the first pulley 15a and the gear 15b are not changed. Thus, the gear 15b remains engaged with the gear 16a.

The drive force of the drive motor 16c is transmitted to the first pulley 15a through the gear trains 16b and 16a and gear 15b, and then the first pulley 15a is rotated. The belt 15d is moved in accordance with the rotation of the first pulley 15a, and the belt 15d rotates the second pulley 15c. When the second pulley 15c rotates, the conveyance alignment roller 13 can be rotated. When the drive direction of the drive motor 16c is changed, rotation directions D1 and D2 (see FIG. 3) of the conveyance alignment roller 13 can be changed.

On the other hand, one end of a coil spring (urging member) 18 is fixed to one end 14a1 of the link member 14a, and the other end of the coil spring 18 is fixed to the main body of the finisher 10. The coil spring 18 urges the link member 14a in a direction of an arrow RA1. Besides, a solenoid 17 is connected to the one end 14a1 of the link member 14a.

The solenoid 17 includes a movable iron core 17a, and an end of the movable iron core 17a is fixed to the one end 14a1 of the link member 14a. The movable iron core 17a is moved by switching between energization and non-energization of the solenoid 17. When the solenoid 17 is energized, the movable iron core 17a is moved in a direction against the urging force of the coil spring 18, and rotates the link member 14a in a direction of an arrow RA2. When the energization to the solenoid 17 is inhibited, the rotation of the link member 14a by the movable iron core 17a is released, and the link member 14a is rotated in the direction of the arrow RA1 by the urging force of the coil spring 18.

When the link member 14a is rotated, the link member 14b is also rotated, and the conveyance alignment rollers 13 and the flapper 12 can be moved in accordance with the rotation of the link members 14a and 14b.

When the link member 14a is rotated in the direction of the arrow RA2, as shown in FIG. 4, the conveyance alignment roller 13 can be brought into contact with the upper pinch roller 19a. When the conveyance alignment roller 13 contacts with the upper pinch roller 19a, the front end 12a of the flapper 12 is positioned below a nip between the conveying rollers 106. The sheet passing through the conveying rollers 106 contacts with the upper surface of the flapper 12, moves along the flapper 12, and proceeds to the upper pinch roller 19a. The upper pinch roller 19a, together with the conveyance alignment roller 13, rotates and conveys the sheet from the conveying roller 106 to the second storage tray 22.

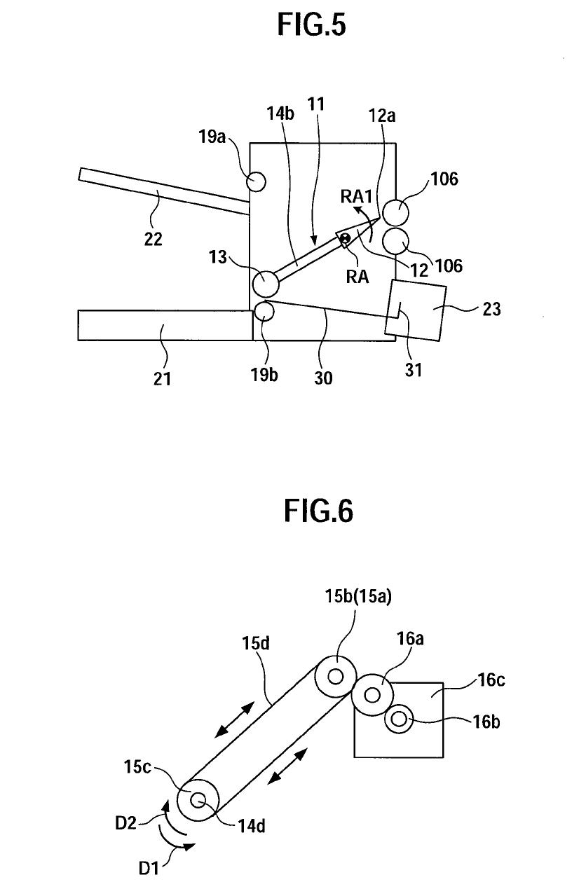

When the link member 14a is rotated in the direction of the arrow RA1, as shown in FIG. 5, the conveyance alignment roller 13 can be brought into contact with the lower pinch roller 19b. When the conveyance alignment roller 13 is in contact with the lower pinch roller 19b, the front end 12a of the flapper 12 is positioned above the nip between the conveying rollers 106. The sheet passing through the conveying rollers 106 contacts with the lower surface of the flapper 12, moves along the flapper 12, and proceeds to the lower pinch roller 19b. The lower pinch roller 19b, together with the conveyance alignment roller 13, rotates.

As shown in FIGS. 4 and 5, a processing tray 30 is disposed below the conveyance path changing mechanism 11. The sheet proceeding to the lower pinch roller 19b from the conveying roller 106 is first stacked on the processing tray 30. An alignment pawl 31 is provided at the end of the processing tray 30, and the alignment pawl 31 is used for aligning the sheets stacked on the processing tray 30.

When the conveyance alignment roller 13 is rotated in a direction of an arrow D2 of FIG. 6 in a state where the sheet stacked on the processing tray 30 is pinched between the conveyance alignment roller 13 and the lower pinch roller 19b, the sheet stacked on the processing tray 30 can be conveyed to the first storage tray 21.

When the conveyance alignment roller 13 is rotated in a direction of an arrow D1 of FIG. 6, the sheet can be brought into contact with the alignment pawl 31 of the processing tray 30. The sheet in contact with the alignment pawl 31 remains pinched between the conveyance alignment roller 13 and the lower pinch roller 19b.

When plural sheets are brought into contact with the alignment pawl 31, the plural sheets can be aligned. Then, the stapler 23 can staple the plural aligned sheets. The stapled sheets can be moved to the first storage tray 21 by rotating the conveyance alignment roller 13 in the direction of the arrow D2 of FIG. 6.

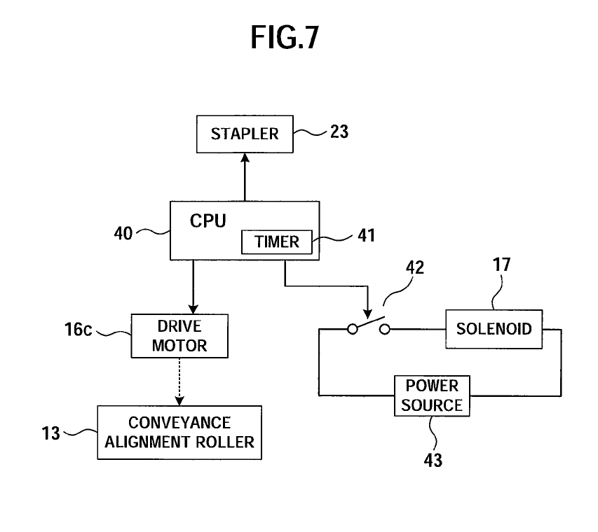

Next, a circuit structure for operating the finisher 10 will be described with reference to FIG. 7.

A CPU 40 controls the operation of the image forming apparatus 100 and includes a timer 41. The drive motor 16c operates based on a control signal from the CPU 40, and rotates the conveyance alignment roller 13 as stated above. As the drive motor 16c, for example, a stepping motor can be used.

The CPU 40 permits energization to the solenoid 17 or inhibits energization to the solenoid 17. Specifically, the solenoid 17 is connected to a power source 43 through a switch 42, and the CPU 40 controls on and off of the switch 42. As stated above, the solenoid 17 rotates the link members 14a and 14b in accordance with the switching between the energization and the non-energization. Besides, the CPU 40 controls the operation of the stapler 23.

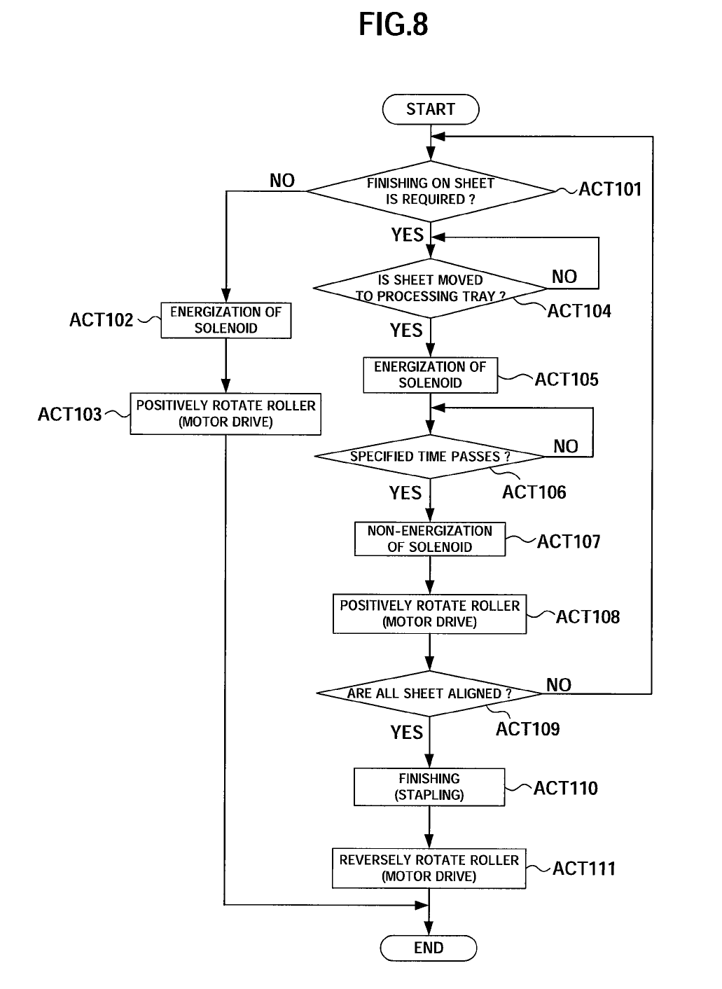

Next, the operation of the finisher 10 of this embodiment will be described with reference to FIG. 8. The CPU 40 performs the process shown in FIG. 8. The conveyance path changing mechanism 11 of the finisher 10 is in, as an initial state, a state (shown in FIG. 5) in which the conveyance alignment roller 13 is in contact with the lower pinch roller 19b. In the initial state, energization to the solenoid 17 is inhibited.

The CPU 40 determines whether finishing is required on a sheet conveyed by the conveying roller 106 from the fuser unit (ACT 101). Information relating to the finishing can be inputted by the user's operation of the operation panel 105 or can be inputted by communication from the outside of the image forming apparatus 100. In this embodiment, as the finishing, stapling is performed by the stapler 23.

If the finishing is not required on the sheet, the CPU changes the switch 42 from OFF to ON, and permits energization to the solenoid 17 (ACT 102). The movable iron core 17a is moved according to the energization of the solenoid 17, so that the link member 14a is rotated in the direction of the arrow RA2 against the urging force of the coil spring 18. The conveyance alignment roller 13 is separated from the lower pinch roller 19b, and contacts with the upper pinch roller 19a.

The CPU 40 drives the drive motor 16c, and rotates the conveyance alignment roller 13 in the direction (positive direction) of the arrow D1 of FIG. 3 (ACT 103). FIG. 3 and FIG. 4 are views when the conveyance alignment roller 13 is in contact with the upper pinch roller 19a.

The sheet discharged from the conveying roller 106 moves along the flapper 12, and moves to the upper pinch roller 19a. The sheet is discharged to the second storage tray 22 by the rotation of the conveyance alignment roller 13 and the upper pinch roller 19a.

In the process of ACT 101, if the CPU 40 determines that the finishing on the sheet is required, the CPU stands by until the sheet discharged from the conveying roller 106 is guided to the processing tray 30 by the flapper 12 (ACT 104). Specifically, the conveyance path changing mechanism 11 is placed in the state shown in FIG. 5 until a specified time passes after the front end of the sheet passes through the conveying roller 106. It can be detected by using a sensor whether the front end of the sheet passes through the conveying roller 106.

When the front end of the sheet moves to the processing tray 30, the CPU 40 permits energization of the solenoid 17, so that the link member 14a is rotated in the direction of the arrow RA2, and the conveyance alignment roller 13 is moved in the direction of separating from the lower pinch roller 19b (processing tray 30) (ACT 105).

By this, the front end of the sheet discharged from the conveying roller 106 passes through between the conveyance alignment roller 13 and the lower pinch roller 19b. In this embodiment, the movement of the sheet discharged from the conveying roller 106 is not hindered by the conveyance alignment roller 13.

In the process of ACT 105, a movement space of the sheet has only to be formed between the conveyance alignment roller 13 and the lower pinch roller 19b. The conveyance alignment roller 13 can be moved to a position where it contacts with the upper pinch roller 19a or may not be moved to the position.

The CPU 40 uses the timer 41 and stops the conveyance alignment roller 13 at a position where it is separate from the lower pinch roller 19b until a specified time passes (ACT 106). The specified time is the time between the timing when the conveyance alignment roller 13 is moved in the direction of separating from the lower pinch roller 19b and the timing when the discharge of the sheet from the conveying roller 106 is completed.

In this embodiment, the specified time is previously set in view of the time until the sheet is discharged from the conveying roller 106 after the sheet reaches the conveying roller 106. A sensor can detect that the whole sheet is discharged from the conveying roller 106.

The sheet discharged from the conveying roller 106 is stacked on the processing tray 30. When the specified time passes, the CPU 40 inhibits energization of the solenoid 17, so that the link member 14a is rotated in the direction of the arrow RA1 (ACT 107). By this, the conveyance alignment roller 13 is moved to the lower pinch roller 19b, and the sheet stacked on the processing tray 30 is pinched between the conveyance alignment roller 13 and the lower pinch roller 19b.

The CPU 40 drives the drive motor 16c, and rotates the conveyance alignment roller 13 in the direction (positive direction) of the arrow D1 of FIG. 6 (ACT 108). By this, the sheet pinched between the conveyance alignment roller 13 and the lower pinch roller 19b moves along the processing tray 30, and proceeds to the stapler 23. The end of the sheet contacts with the alignment pawl 31 of the processing tray 30 and is positioned.

For example, the number of drive pulses inputted to the drive motor (stepping motor) 16c is controlled, so that the sheet can be moved to a position where the sheet contacts with the alignment pawl 31.

The CPU 40 determines whether the alignment process is completed for all sheets on which the finishing is performed (ACT 109). If the alignment process on all sheets is not completed, return is made to the process of ACT 101. Besides, if the alignment process on all sheets is completed, the CPU 40 drives the stapler 23 to staple the plural positioned sheets (ACT 110).

When the stapling is completed, the CPU 40 drives the drive motor 16c, and rotates the conveyance alignment roller 13 in the direction (reverse direction) of the arrow D2 of FIG. (ACT 111). The conveyance alignment roller 13 moves the plural stapled sheets to the first storage tray 21.

In this embodiment, the sheet subjected to the finishing is stacked on the first storage tray 21, and the sheet not subjected to the finishing is stacked on the second storage tray 22. Then, while the narrow space (sheet discharge space) S formed between the image forming section 102 and the image reading section 103 is efficiently used, the sheet can be distributed.

Incidentally, in this embodiment, although the finishing is performed, the finishing can be omitted. That is, the conveyance path changing mechanism 11 is used, and the sheet from the conveying roller 106 can be merely distributed to the first storage tray 21 and the second storage tray 22. Specifically, the sheets can be distributed according to a job. For example, a FAX sheet is discharged to the first storage tray 21, and a copied or printed sheet is discharged to the second storage tray 22.

Besides, in this embodiment, although the two storage trays 21 and 22 are provided in the sheet discharge space S, three or more storage trays can also be provided. When three or more storage trays are used, a mechanism to cause the pinch roller to enter or retract from the movement locus of the conveyance alignment roller 13 can be provided. When the pinch roller is made to enter the movement locus of the conveyance alignment roller 13, the conveyance alignment roller can be brought into contact with this pinch roller. Then, the sheet can be discharged to the storage tray disposed correspondingly to the pinch roller.

In this embodiment, in order to rotate the link members 14a and 14b around the rotation axis RA, the solenoid 17 and the coil spring 18 are used. However, another mechanism capable of rotating the link members 14a and 14b can also be used. For example, the rotation force of a motor is transmitted to the link member 14a through gear trains, and the link member 14a can be rotated. When the motor is stopped at a specified rotation angle, the conveyance path changing mechanism 11 can be changed between the states shown in FIG. 4 and FIG. 5.

Although the invention is described in detail in connection with the specific embodiment, it would be obvious for one of ordinary skill in that art that various modifications and alterations can be made.

What is claimed is:

1. A sheet conveying apparatus configured to distribute and convey sheets to a plurality of storage trays, comprising:
a flapper configured to guide a sheet to each of the plurality of storage trays by changing an angle thereof;
a conveying roller configured to discharge the sheet moved along the flapper to each of the storage trays; and
a link member which is connected to the flapper and the conveying roller, and rotates to change the angle of the flapper and a position of the conveying roller with respect to the plurality of storage trays.

2. The apparatus according to claim 1, further comprising:
an urging member configured to urge the link member in a first rotation direction; and
an actuator configured to rotate the link member in a second rotation direction against an urging force of the urging member, the second rotation direction being a reverse direction to the first rotation direction,.

3. The apparatus according to claim 2, wherein the actuator is a solenoid connected to the link member.

4. The apparatus according to claim 3, wherein the solenoid rotates the link member in the second rotation direction when the solenoid is energized, and the solenoid permits the link member to rotate in the first rotation direction when the solenoid is de-energized.

5. The apparatus according to claim 1, further comprising a plurality of pinch rollers which are disposed at positions corresponding to the plurality of storage trays and, together with the conveying roller, rotate to convey the sheet.

6. The apparatus according to claim 5, wherein the conveying roller contacts with the pinch roller corresponding to the rotation angle of the link member among the plurality of pinch rollers.

7. The apparatus according to claim 1, wherein the flapper rotates around a rotation axis of the link member.

8. The apparatus according to claim 1, further comprising:
a motor configured to generate a drive force to rotate the conveying roller; and
a power transmission mechanism configured to transmit the drive force of the motor to the conveying roller.

9. The apparatus according to claim 8, wherein the power transmission mechanism includes:
a first pulley which is disposed on a rotation axis of the link member and to which the drive force from the motor is inputted;
a second pulley which is disposed on a rotation axis of the conveying roller and rotates together with the conveying roller; and
a belt which engages with the first pulley and the second pulley and receives rotation of the first pulley to rotate the second pulley.

10. An image forming apparatus comprising:
an image forming section configured to form an image on a sheet; and
the sheet conveying apparatus according to claim 1, configured to convey the sheet on which the image is formed by the image forming section to the plurality of storage trays.

11. The image forming apparatus according to claim 10, wherein the plurality of storage trays are disposed in a sheet discharge space formed above the image forming section and disposed side by side in an up-and-down direction of the image forming apparatus.

12. The image forming apparatus according to claim 11, further comprising an image reading section which is disposed above the sheet discharge space and reads image information of a document.

13. The image forming apparatus according claim 10, further comprising:
a processing tray on which the sheet from the image forming section is stacked; and
a finishing unit configured to perform finishing on the sheet stacked on the processing tray,
wherein the sheet conveying apparatus causes the sheet from the image forming section to proceed to the processing tray before conveying the sheet to the storage tray.

14. The image forming apparatus according to claim 13, wherein the conveying roller of the sheet conveying apparatus is separate from the processing tray until the sheet from the image forming section is stacked on the processing tray.

15. The image forming apparatus according to claim 14, wherein the conveying roller contacts with the sheet on the processing tray by the rotation operation of the link member after the sheet from the image forming section is stacked on the processing tray.

16. The image forming apparatus according to claim 15, wherein the conveying roller rotates in a direction reverse to a direction of rotation performed when the sheet is moved to the storage tray, and moves the sheet stacked on the processing tray to a processing position of the finishing unit.

17. The image forming apparatus according to claim 16, wherein the conveying roller is in contact with the sheet subjected to the finishing by the finishing unit.

18. The image forming apparatus according to claim 17, wherein the conveying roller moves the sheet subjected to the finishing to the storage tray by a rotation operation after the finishing is completed.

19. The image forming apparatus according to claim 13, wherein the plurality of storage trays include:
a first storage tray which is disposed at a position corresponding to the processing tray and to which the sheet on the processing tray is conveyed; and
a second storage tray positioned above the first storage tray.

20. A sheet conveying method for distributing and conveying sheets to a plurality of storage trays, comprising:
rotating a link member in a first rotation direction by using an urging force of an urging member, the link member being connected to a flapper and a conveying roller;
rotating the link member in a second rotation direction by an actuator, the second rotation direction being a reverse direction to the first rotation direction, the actuator generating a force against the urging force of the urging member;
guiding the sheet to each of the plurality of storage trays by changing an angle of the flapper through the rotation of the link member in the first and second directions; and
discharging the sheet moved along the flapper to each of the storage trays by changing a position of the conveying roller with respect to the plurality of storage trays through the rotation of the link member and then rotating the conveying roller.
